(19) United States
(12) Patent Application Publication
(10) Pub. No.: US 2008/0217253 A1
(43) Pub. Date: Sep. 11, 2008

(54) Composition, system and method for making the composition and system and method for using the composition

(76) Inventor: John Graham, Dolton, IL (US)

Correspondence Address: Patents+ TMS;A Professional Corporation, 2849 W. Armitage Ave., Chicago, IL, 60647, US

(21) Appl. No.: 11/714,368

(22) Filed: Mar. 6, 2007

(51) Int. Cl. B01J 8/20

(52) U.S. Cl. 210/695; 210/222; 516/97

(57) ABSTRACT

A composition, a system and a method for making the composition and a system and a method for using the composition are provided. The composition, the system and the method for making the composition and the system and the method for using the composition are used to passively treat a solution. The composition is a mixture of a catalyst-altered water, a colloidal solution and a treated water. The composition is produced by mixing the catalyst-altered water, the colloidal solution and the treated water at room temperature. The composition, the system and the method for making the composition and the system and the method for using the composition have a sphere and/or a tube for housing the composition in an internal compartment of the sphere and/or the tube. Exposure of the solution to the composition and/or to an exterior surface of the sphere and/or the tube containing the composition raises a pH and/or an alkalinity of the solution and/or changes a structure of the solution.

### BACKGROUND OF THE INVENTION

The present invention generally relates to a composition, a system and a method for making the composition and a system and a method for using the composition. More specifically, the present invention relates to a composition, a system and a method for making the composition and a system and a method for using the composition that may be used to passively treat a solution. The solution may be, for example, a solid, a liquid, a gas and/or a mixture of the solid, the liquid, and/or the gas. The solution may be, for example, water, gasoline and/or the like. The composition, the system and the method for making the composition and the system and the method for using the composition may have a sphere and/or a tube for housing the composition in an internal compartment of the sphere and/or the tube.

The sphere and/or the tube may be hermetically sealed forming an airtight seal between the composition within the internal compartment of the sphere and/or the tube and an exterior surface of the sphere and/or the tube. The solution may be exposed to and/or may be passed within a close proximity of the composition and/or the exterior surface of the sphere and/or the tube to passively treat the solution. The exposure of the solution to the composition and/or to the exterior surface of the sphere and/or the tube containing the composition may raise a pH and/or an alkalinity of the solution and/or may change a frequency of the solution. Further, exposure of the solution to the composition and/or to the exterior surface of the sphere and/or the tube containing the composition may create an energy gap in a superconductor crystal lattice of molecules of the solution. Water treated by the composition and/or the system and method for treating the solution may be consumed by a human and/or an animal resulting in hydration of red blood cells of the human and/or of the animal within twenty minutes of consumption. Further, gasoline treated by the composition and/or the system and method for treating the solution may be combusted resulting in a reduction of carbon monoxide emissions by up to fifty (50) percent.

It is generally known that solutions, such as, for example, water with an elevated pH and/or alkalinity are more resistant to bacterial growth, microbial growth, and/or other contamination in the solution. Further, it is generally known that water with an elevated pH and/or alkalinity may be biologically beneficial to organisms who consume the water with the elevated pH and/or alkalinity. Known methods of elevating the pH and/or the alkalinity of water include mixing the water with another more alkaline solution. Further, known methods of raising the pH and/or the alkalinity of water include exposing the water to magnetic fields of magnets to alter the structure of the water thus raising the pH and/or the alkalinity of the water.

Further, the altered structure of water exposed to magnetic fields of magnets may positively affect a potential to dissolve various minerals and/or vitamins. Still further, the altered structure of water exposed to magnetic fields of magnets may increase bioavailability of the water, and when consumed by organisms, may increase biological performance of the organisms. Moreover, water with an elevated pH and/or alkalinity and/or water exposed to magnetic fields of magnets may have beneficial effects in industrial and/or environmental applications.

A need, therefore, exists for a composition, a system and a method for making the composition and a system and a method for using the composition that may be used to passively treat a solution without adding chemicals to the solution and/or without exposing the solution to magnets. Additionally, a need exists for a composition, a system and a method for making the composition and a system and a method for using the composition that may have a sphere and/or a tube for housing the composition in an internal compartment of the sphere and/or the tube. Further, a need exists for a composition, a system and a method for making the composition and a system and a method for using the composition that may create a monopole and/or a dipole magnetic field for treating a solution. The solution may be exposed to and/or may be passed within a close proximity of the magnetic field. Moreover, a need exists for a composition, a system and a method for making the composition and a system and a method for using the composition that may raise the pH of water, may raise the alkalinity of water and/or may alter the structure of water in a way that may be beneficial to an organism who consumes the water and/or to an application that uses the water.

### SUMMARY OF THE INVENTION

The present invention generally relates to a composition, a system and a method for making the composition and a system and a method for using the composition. More specifically, the present invention relates to a composition, a system and a method for making the composition and a system and a method for using the composition that may be used to passively treat a solution. The solution may be, for example, a solid, a liquid, a gas and/or a mixture of the solid, the liquid, and/or the gas. The solution may be, for example, water, gasoline and/or the like.

The composition may be a mixture of a catalyst-altered water, a colloidal solution and/or a treated water. The composition may be produced by mixing the catalyst-altered water, the colloidal solution and/or the treated water at room temperature.

The composition, the system and the method for making the composition and the system and the method for using the composition may have a sphere and/or a tube for housing the composition in an internal compartment of the sphere and/or the tube. The sphere and/or the tube may be manufactured from a plastic material, such as, for example, polyethylene, polyvinyl chloride (PVC) and/or the like

The composition may be placed in the internal compartment of the sphere and/or the tube. The sphere and/or the tube may be hermetically sealed forming an airtight seal between the composition within the internal compartment of the sphere and/or the tube and an exterior surface of the sphere and/or the tube. The sphere and/or the tube containing the composition my be placed in an array and/or in a filter with other like spheres and/or tubes. The solution may be passed through the array and/or the filter exposing the solution to and/or within a close proximity of the composition and/or the exterior surface of the sphere and/or the tube to passively treat the solution. The exposure of the solution to the composition and/or to the exterior surface of the sphere and/or the tube containing the composition may raise a pH and/or an alkalinity of the solution, may change a frequency of the solution and/or may alter a structure of the solution. Further, exposure of the solution to the composition and/or to the exterior surface of the sphere and/or the tube containing the composition may create an energy gap in a superconductor crystal lattice of molecules of the solution.

To this end, in an embodiment of the present invention, a composition for passively treating a solution is provided. The composition has a catalyst-altered water wherein the catalyst-altered water has a micelle. Further, the composition has a colloidal solution wherein the colloidal solution is a colloidal silver solution. Further, the composition has water.

In an embodiment, the colloidal silver solution is twenty percent silver by volume.

In an embodiment, the water is carbon-filtered water.

In an embodiment, the water has a pH greater than seven.

In an embodiment, the water has an energy gap in a superconductor crystal lattice of one or more molecules of the water.

In an embodiment, the composition comprises one part by volume of the catalyst-altered, two parts by volume of the colloidal solution and sixty-four parts by volume of the water.

In another embodiment of the present invention, a system for passively treating a solution is provided. The system has a first container having an external surface and an internal compartment wherein the internal compartment of the container is filled with a composition wherein the composition has a catalyst-altered water, a colloidal solution and water wherein the composition is hermetically sealed within the internal compartment from the external surface. Further, the system has a fixture that houses the first container wherein the fixture is sized to allow the solution to be exposed to the external surface of the first container.

In an embodiment, the first container is made from plastic.

In an embodiment, the external surface of the first container forms a sphere about a central axis of the first container.

In an embodiment, the external surface of the first container forms a tube about a central axis of the first container.

In an embodiment, the system has a second container having an external surface and an internal compartment wherein the internal compartment of the second container is filled with the composition wherein the composition is hermetically sealed within the internal compartment of the second container from the external surface of the second container.

In another embodiment of the present invention, a method for treating a solution is provided. The method has the step of producing a composition by mixing a first volume of a catalyst-altered water, a first volume of a colloidal solution and a first volume of water. Further, the method has the step of sealing a volume of the composition within an internal compartment of a first container wherein the first container has an external surface wherein the volume of the composition is hermetically sealed within the internal compartment of the first container from the external surface of the first container. Further, the method has the step of exposing the solution to the first container within a close proximity of the external surface of the first container.

In an embodiment, the method has the step of filtering the first volume of the water with a carbon-filtration process before producing the composition.

In an embodiment, the method has the step of treating the first volume of water by exposing the first volume of water within a close proximity of an external surface of a second container wherein the second container is filled with a preliminary composition wherein the preliminary composition has a second volume of the catalyst-altered water, a second volume of the colloidal solution and a second volume of water.

In an embodiment, the method has the step of housing the first container in a fixture before exposing the solution to the first container.

In an embodiment, the first container is made from plastic.

In an embodiment, the external surface of the first container forms a sphere about a central axis of the first container.

In an embodiment, the external surface of the first container forms a tube about a central axis of the first container.

In an embodiment, the catalyst altered-water is Dr. Willard's™ Water Clear Concentrate.

In an embodiment, the colloidal solution is a silver colloidal solution that is twenty percent silver by volume.

It is, therefore, an advantage of the present invention to provide a composition, a system and a method for making the composition and a system and a method for using the composition that may be used to passively treat a solution.

Another advantage of the present invention is to provide a composition, a system and a method for making the composition and a system and a method for using the composition that may be used to passively treat a solution without adding chemicals to the solution.

And, another advantage of the present invention is to provide a composition, a system and a method for making the composition and a system and a method for using the composition that may be used to passively treat a solution without exposing the solution to a magnetic field of a magnet.

Yet another advantage of the present invention is to provide a composition, a system and a method for making the composition and a system and a method for using the composition that may be used to passively treat a solution wherein the solution is water.

A further advantage of the present invention is to provide a composition, a system and a method for making the composition and a system and a method for using the composition that may be used to passively treat a solution wherein the composition may be a mixture of a catalyst-altered water, a colloidal solution and/or a treated water. The composition may be produced by mixing the catalyst-altered water, the colloidal solution and/or the treated water at room temperature.

Moreover, an advantage of the present invention is to provide a composition, a system and a method for making the composition and a system and a method for using the composition that may be used to passively treat a solution that may have a sphere and/or a tube for housing the composition in an internal compartment of the sphere and/or the tube. The composition may be placed in the internal compartment of the sphere and/or the tube. The sphere and/or the tube may be hermetically sealed forming an airtight seal between the composition within the internal compartment of the sphere and/or the tube and an exterior surface of the sphere and/or the tube.

And, another advantage of the present invention is to provide a composition, a system and a method for making the composition and a system and a method for using the composition that may be used to passively treat a solution wherein the sphere and/or the tube containing the composition may be placed in an array and/or in a filter with other like spheres and/or tubes. The solution may be passed through the array and/or the filter exposing the solution to and/or within a close proximity of the composition and/or the exterior surface of the sphere and/or the tube in order to passively treat the solution.

Yet another advantage of the present invention is to provide a composition, a system and a method for making the composition and a system and a method for using the composition that may be used to passively treat a solution wherein the exposure of the solution to the composition and/or to the exterior surface of the sphere and/or the tube containing the composition may raise a pH and/or an alkalinity of the solution, may change a frequency of the solution and/or may alter a structure of the solution.

A further advantage of the present invention is to provide a composition, a system and a method for making the composition and a system and a method for using the composition that may be used to passively treat a solution wherein exposure of the solution to the composition and/or to the exterior surface of the sphere and/or the tube containing the composition may create an energy gap in a superconductor crystal lattice of molecules of the solution.

Moreover, an advantage of the present invention is to provide a composition, a system and a method for making the composition and a system and a method for using the composition that may be used to passively treat a solution that may alter the structure of the water in a way that may be beneficial to an organism that consumes the water and/or to an application that uses the water.

And, another advantage of the present invention is to provide a composition, a system and a method for making the composition and a system and a method for using the composition that may be used to passively treat a solution for use in municipal water treatment, fish farms, sludge treatment plants, water boilers, cooling towers, auto/diesel fuel treatment, gasoline/diesel storage tanks, pools, spas, aquariums, water for poultry, water for livestock, water for pets, farming irrigation, commercial food processing, bottled water, industrial smoke emissions, intravenous solutions for hospitals and/or processing of water for use in pharmaceuticals.

Additional features and advantages of the present invention are described in, and will be apparent from, the detailed description of the presently preferred embodiments.

### BRIEF DESCRIPTION OF THE DRAWINGS

FIG. 1 illustrates a system for treating water in an embodiment of the present invention.

FIG. 2 illustrates a system for treating water in an embodiment of the present invention.

FIG. 3 illustrates a system for treating a solution in an embodiment of the present invention.

FIG. 4 illustrates a system for treating a solution in an embodiment of the present invention.

FIG. 5 illustrates a method for making a composition and a method for using the composition in an embodiment of the present invention.

FIG. 6 illustrates a system for treating a solution in an embodiment of the present invention.

FIG. 7 illustrates a system for treating a solution in an embodiment of the present invention.

### DETAILED DESCRIPTION OF THE PRESENTLY PREFERRED EMBODIMENTS

The present invention generally relates to a composition, a system and a method for making the composition and a system and a method for using the composition. More specifically, the present invention relates to a composition, a system and a method for making the composition and a system and a method for using the composition that may be used to passively treat a solution. The solution may be, for example, a solid, a liquid, a gas and/or a mixture of the solid, the liquid, and/or the gas. The solution may be, for example, water, gasoline and/or the like.

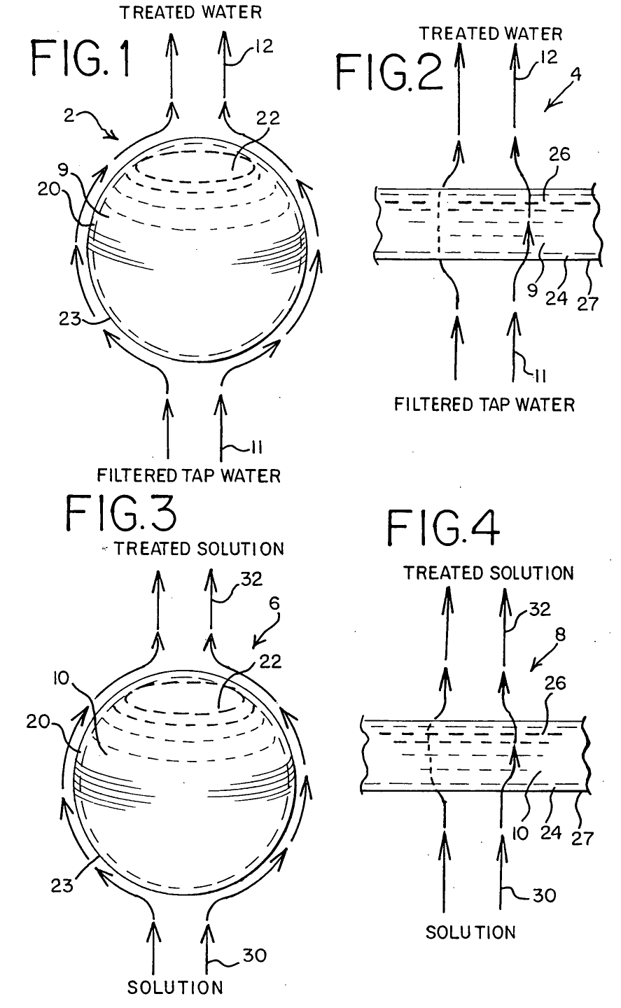

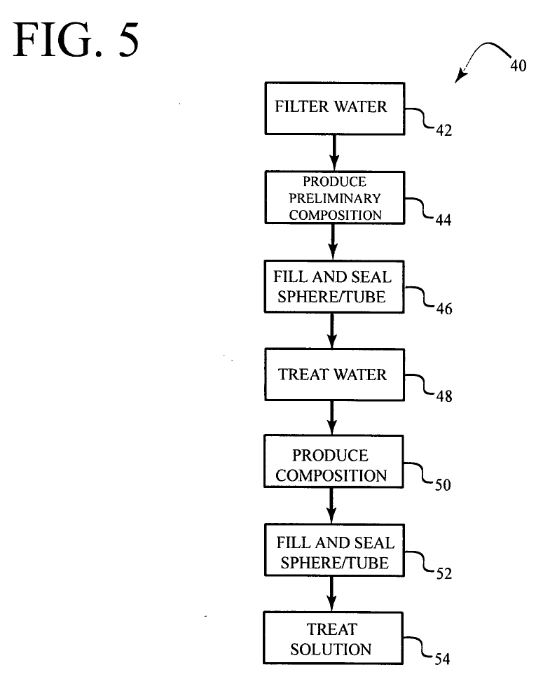

Referring now to the drawings wherein like numerals refer to like parts, FIGS. 1-4, 6 and 7 illustrate systems 2, 4, 6, 8, 60 and 62, respectively, for treating a solution 11, 30 in an embodiment of the present invention. FIG. 5 illustrates system 40 for making a composition and a method for using the composition in an embodiment of the present invention.

In an embodiment, the composition 10 may be a mixture of a catalyst-altered water, a colloidal solution and/or a treated water 12. The composition 10 may be produced by mixing the catalyst-altered water, the colloidal solution and/or the treated water 12 at a temperature, such as, for example, room temperature. It should be understood that the composition 10 may be produced by mixing the catalyst-altered water, the colloidal solution and/or the treated water 12 at any temperature as known to one having ordinary skill in the art.

The catalyst-altered water may be a solution of water, sodium metasilicate, sulfated castor oil, a micelle, refined lignite, calcium chloride and/or magnesium sulfate. The catalyst-altered water may be a commercially available solution, such as, for example Dr. Willard's Water™ Dark Concentrate, Dr. Willard's™ Water Clear Concentrate, carbonaceous activated water and/or biowater. It should be understood that the catalyst-altered water may be any concentration and/or solution having chemical properties the same as and/or similar to Dr. Willard's Water™ Dark Concentrate, Dr. Willard's™ Water Clear Concentrate, carbonaceous activated water and/or biowater as known to one having ordinary skill in the art.

The colloidal solution may be, for example, colloidal silver solution and/or the like. In an embodiment, the colloidal solution may be twenty percent silver by volume. It should be understood that the colloidal solution may be any concentration and/or solution having chemical properties the same as and/or similar to colloidal silver solution as known to one having ordinary skill in the art.

The composition 10, the system and the method for making the composition and the system and the method for using the composition 10 may have a sphere 20 and/or a tube 24 for housing the composition in an internal compartment 22, 26 of the sphere 20 and/or the tube 24, respectively. The sphere 20 and/or the tube 24 may be manufactured from a plastic material, such as, for example, polyethylene, polyvinyl chloride (PVC) and/or the like. It should be understood that the sphere 20 and/or the tube 24 may be any sphere and/or tube having an internal compartment 22, 26 as known to one having ordinary skill in the art.

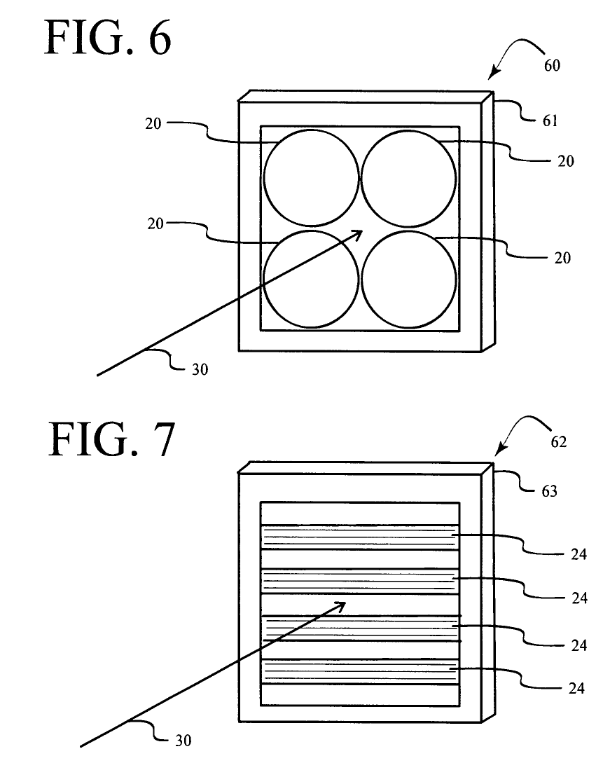

As shown in FIGS. 3 and 4, the composition 10 may be placed in the internal compartment 22, 26 of the sphere 20 and/or the tube 24. The sphere 20 and/or the tube 24 may be hermetically sealed forming an airtight seal between the composition 10 within the internal compartment 22, 26 of the sphere 20 and/or the tube 24 and an exterior surface 23, 27 of the sphere 20 and/or the tube 24. The sphere 20 and/or the tube 24 containing the composition 10 may be housed in a fixture 61, 63 with other spheres 20 and/or tubes 24 as shown in FIGS. 6 and 7. The solution 30 may be passed through the fixture 61, 63 exposing the solution 30 to and/or within a close proximity of the composition 10 and/or of the exterior surface 23, 27 of the sphere 20 and/or the tube 24 to passively treat the solution 30.

The exposure of the solution 30 to the composition 10 and/or to the exterior surface 23, 27 of the sphere 20 and/or the tube 24 containing the composition 10 may raise a pH and/or an alkalinity of the solution 30, may change a frequency of the solution 30 and/or may alter a structure of the solution 30 producing a treated solution 32. Further, exposure of the solution 30 to the composition 10 and/or to the exterior surface 23, 27 of the sphere 20 and/or the tube 24 containing the composition 10 may create an energy gap in a superconductor crystal lattice of molecules of the solution. It should be understood that the fixture 61, 63 may be any assembly, device and/or apparatus for holding one or more spheres 20 and/or tubes 24 containing the composition 10 that may allow the solution 30 to be to be exposed to and/or circulated within a close proximity of the composition 10 and/or of the exterior surface 23, 27 of one or more of the spheres 20 and/or one or more of the tubes 24 as known to one having ordinary skill in the art.

The treated water 12 may be, for example, a tap water and or the like that may be processed in one and/or more steps. The tap water may be filtered using a water filter, such as, for example, a carbon filter and/or the like creating a filtered tap water 11. A first portion of the filtered tap water 11 may be mixed with a first portion of the catalyst-altered water and/or a first portion of the colloidal solution creating a preliminary composition 9 for producing the treated water 12. The preliminary composition 9 may be placed within and/or may be hermetically sealed within the internal compartment 22, 26 of one or more of the spheres 20 and/or one or more of the tubes 24 as shown in FIGS. 1 and 2. One or more of the spheres 20 and/or one or more of the tubes 24 containing the preliminary composition 9 may be housed in the fixture 61, 63 as shown in FIGS. 6 and 7. A second portion of the filtered tap water 11 may be passed through the fixture 61, 63 exposing the second portion of the filtered tap water 11 to and/or within a close proximity of the preliminary composition 9 and/or of the exterior surfaces 23, 27 of one or more of the spheres 20 and/or the tubes 24 containing the preliminary composition 9 producing the treated water 12. It should be understood that the tap water may be any solution of water and/or may be filtered by any filter and/or filtration system as known to one having ordinary skill in the art.

A second portion of the catalyst-altered water, a second portion of the colloidal solution and/or a first portion of the treated water 12 may be mixed creating the composition 10. One or more portions of the composition 10 may then be hermetically sealed within the internal compartment 22, 26 of one or more of the spheres 20 and/or the tubes 24 and used as herein described above to treat the solution 30.

In an embodiment, the tap water may be, for example, Chicago municipal tap water. The tap water may be filtered using a carbon filter creating the filtered tap water 11. The first portion of the filtered tap water 11 may be approximately one gallon of the filtered tap water 11. The first portion of the catalyst-altered water may be approximately two ounces of Dr. Willard's™ Water Clear Concentrate. The first portion of the colloidal solution may be approximately one hundred twenty eight milliliters of colloidal silver solution wherein the colloidal silver solution may be approximately twenty percent silver by volume. The first portion of the filtered tap water may be mixed with the first portion of the catalyst-altered water and/or the first portion of the colloidal solution creating the preliminary composition 9 for producing the treated water 12.

As shown in FIGS. 1 and 2, the preliminary composition 9 may be place within and/or may be hermetically sealed within the internal compartment 22, 26 of one or more of the spheres 20 and/or one or more of the tubes 24. One or more of the spheres 20 and/or one or more of the tubes 24 containing the preliminary composition 9 may be housed in the fixture 61, 63 as shown in FIGS. 6 and 7. The second portion of the filtered tap water 11 may be one or more gallons of the filtered tap water 11. The second portion of the filtered tap water 11 may be passed through the fixture 61, 63 exposing the second portion of the filtered tap water 11 to and/or within a close proximity of the preliminary composition 9 and/or of the exterior surfaces 23, 27 of one or more of the spheres 20 and/or the tubes 24 producing the treated water 12. It should be understood that the preliminary composition 9 may created by mixing any portions of the filtered tap water 11, the catalyst-altered water and/or the colloidal solution creating the preliminary composition 9 having equivalent proportions of the filtered tap water 11, the catalyst-altered water and/or the colloidal solution as herein described and as known to one having ordinary skill in the art.

In an embodiment, the second portion of the catalyst-altered water may be approximately two ounces of Dr. Willard's™ Water Clear Concentrate. The second portion of the colloidal solution may be approximately one hundred twenty eight milliliter of colloidal silver solution wherein the colloidal silver solution may be approximately twenty percent silver by volume. The first portion of the treated water 12 may be approximately one gallon of the treated water. The second portion of the catalyst-altered water, the second portion of the colloidal solution and/or the first portion of the treated water 12 may be mixed creating the composition 10. One or more portions of the composition 10 may then be hermetically sealed within the internal compartment 22, 26 of one or more of the spheres 20 and/or the tubes 24 and used as herein described above to treat the solution 30 as shown in FIGS. 3 and 4. It should be understood that the composition 10 may be created by mixing any portions of the treated water 12, the catalyst-altered water and/or the colloidal solution creating the composition 10 having equivalent proportions of the treated water 12, the catalyst-altered water and/or the colloidal solution as herein described and as known to one having ordinary skill in the art.

Referring now to FIG. 5, a method 40 for making the composition 10 and/or for using the composition 10 to treat the solution 30 having a sequence of steps is shown. Particularly, the method 40 may filter water to produce filtered water as shown at step 42. In an embodiment, the water may be, for example, tap water and/or the like. The water may be filtered using, for example, a particle filtration process, a carbon filtration process and/or the like. A desired amount of the preliminary composition 9 may be produced by mixing the filtered water, the catalyst-altered water and/or the colloidal solution as shown at step 42. In an embodiment, the preliminary composition 9 may be produced by mixing, for example, approximately one part by volume of the catalyst-altered water, approximately two parts by volume of the colloidal solution and/or approximately sixty-four parts by volume of the filtered water. In an embodiment, the catalyst-altered water that may be used in step 44 may be, for example, Dr. Willard's™ Water Clear Concentrate and/or the like. In an embodiment, the colloidal solution that may be used in step 44 may be, for example, colloidal silver solution and/or the like. In an embodiment, the colloidal solution that may be used in step 44 may be twenty percent silver by volume. In an embodiment the catalyst-altered water that may be used in step 44, the colloidal solution that may be used in step 44 and/or the filtered water that may be used in step 44 may be mixed at, for example, room temperature and/or the like.

A volume of the preliminary composition 9 that may be produced in step 44 may be placed in the sphere 20 and/or the tube 24 as shown in step 46. The volume of the preliminary composition 9 may fill a volume of the internal compartment 22, 26 of the sphere 20 and/or the tube 24 and/or a substantial portion of a volume of the of the internal compartment 22, 26 of the sphere 20 and/or the tube 24. In an embodiment, the sphere 20 and/or the tube 24 may be manufactured from polyethylene, PVC and/or the like. The sphere 20 and/or the tube 24 may be hermetically sealed forming an airtight seal between the preliminary composition 9 within the internal compartment 22, 26 of the sphere 20 and/or the tube 24 and the exterior surface 23, 27 of the sphere 20 and/or the tube 24.

A desired volume of the filtered water may be treated to produce a desired volume of the treated water 12 as shown at step 48. In an embodiment, the desired volume of the filtered water may be passed within a close proximity of the preliminary composition 9 and/or the exterior surface 23, 27 of the sphere 20 and/or the tube 24 containing the preliminary composition 9 to passively treat the desired volume of the filtered water. The exposure of the desired volume of the filtered water to the preliminary composition and/or to the exterior surface 23, 27 of the sphere 20 and/or the tube 24 containing the preliminary composition 9 may raise a pH and/or an alkalinity of the filtered water, may change a frequency of the filtered water and/or may alter a structure of the filtered water producing the desired volume of the treated water 12. In an embodiment, one or more of the spheres 20 and/or the tubes 24 may be housed in the fixture 61, 63 with other spheres 20 and/or tubes 24. In an embodiment, the filtered water may be passed through the fixture 61, 63 to produce the desired volume of the treated water 12.

A desired amount of the composition 10 may be produced by mixing the treated water 12, the catalyst-altered water and/or the colloidal solution as shown at step 50. In an embodiment, the composition 10 may be produced by mixing, for example, approximately one part by volume of the catalyst-altered water, approximately two parts by volume of the colloidal solution and/or approximately sixty-four parts by volume of the treated water 12. In an embodiment, the catalyst-altered water that may be used in step 50 may be, for example, Dr. Willard's™ Water Clear Concentrate and/or the like. In an embodiment, the colloidal solution that may be used in step 50 may be, for example, colloidal silver solution and/or the like. In an embodiment, the colloidal solution that may be used in step 50 may be twenty percent silver by volume. In an embodiment the catalyst-altered water that may be used in step 50, the colloidal solution that may be used in step 50 and/or the filtered water that may be used in step 50 may be mixed at, for example, room temperature and/or the like.

A volume of the composition 10 that may be produced in step 50 may be placed in the sphere 20 and/or the tube 24 as shown at step 52. The volume of the composition 10 may fill the volume of the internal compartment 22, 26 of the sphere 20 and/or the tube 24 and/or a substantial portion of the volume of the of the internal compartment 22, 26 of the sphere 20 and/or the tube 24. In an embodiment, the sphere 20 and/or the tube 24 that may be used in step 52 may be manufactured from polyethylene, PVC and/or the like. The sphere 20 and/or the tube 24 that may be used in step 52 may be hermetically sealed forming an airtight seal between the composition 10 within the internal compartment 22, 26 of the sphere 20 and/or the tube 24 and the exterior surface 23, 27 of the sphere 20 and/or the tube 24.

A desired volume of the solution 30 may be treated to produce a desired volume of the treated solution 32 as shown at step 54. In an embodiment, the desired volume of the solution 30 may be passed within a close proximity of the composition 10 and/or the exterior surface 23, 27 of the sphere 20 and/or the tube 24 containing the composition 10 to passively treat the desired volume of the solution 30. The exposure of the desired volume of the solution 30 to the composition 10 and/or to the exterior surface 23, 27 of the sphere 20 and/or the tube 24 containing the composition 10 may raise the pH and/or the alkalinity of the solution 30, may change a frequency of the solution 30 and/or may alter the structure of the solution producing the desired volume of the treated solution 32. In an embodiment, one or more of the spheres 20 and/or the tubes 24 may be housed in the fixture 61, 63 with other like spheres 20 and/or tubes 24. In an embodiment, the solution 30 may be passed through the fixture 61, 63 to produce the desired volume of the treated solution 32.

In an embodiment, the solution 30 may be, for example, gasoline. After the gasoline is treated as shown in FIGS. 3-5, the gasoline may exhibit an altered chemical structure and/or may release less carbon monoxide when combusted in an engine. In an embodiment, the solution 30 may be, for example, a solution used in applications including, but not limited, to automobile/diesel fuel treatment and/or gasoline/diesel storage tanks.

In an embodiment, the solution 30 may be, for example, water, gas and/or other solutions used in applications including, but not limited to municipal water treatment, fish farms, sludge treatment, water boilers, cooling towers, pools, spas, aquariums, animal feed, farming irrigation, commercial food processing, bottled water, treatment of industrial smoke emissions, intravenous solutions, and/or pharmaceutical products wherein an elevated pH and/or alkalinity of the solution and/or an altered chemical structure of the solution is desired without requiring the use of additive chemicals and/or using magnets.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A composition for passively treating a solution, the composition comprising:
a catalyst-altered water wherein the catalyst-altered water has a micelle;
a colloidal solution wherein the colloidal solution is a colloidal silver solution; and
water.

2. The composition of claim 1 wherein the colloidal silver solution is twenty percent silver by volume.

3. The composition of claim 1 wherein the water is carbon-filtered water.

4. The composition of claim 1 wherein the water has a pH greater than seven.

5. The composition of claim 1 wherein the water has an energy gap in a superconductor crystal lattice of one or more molecules of the water.

6. The composition of claim 1 wherein the composition comprises one part by volume of the catalyst-altered, two parts by volume of the colloidal solution and sixty-four parts by volume of the water.

7. A system for passively treating a solution, the system comprising:
a first container having an external surface and an internal compartment wherein the internal compartment of the container is filled with a composition wherein the composition has a catalyst-altered water, a colloidal solution and water wherein the composition is hermetically sealed within the internal compartment from the external surface; and
a fixture that houses the first container wherein the fixture is sized to allow the solution to be exposed to the external surface of the first container.

8. The system of claim 7 wherein the first container is made from plastic.

9. The system of claim 7 wherein the external surface of the first container forms a sphere about a central axis of the first container.

10. The system of claim 7 wherein the external surface of the first container forms a tube about a central axis of the first container.

11. The system of claim 7 further comprising:
a second container having an external surface and an internal compartment wherein the internal compartment of the second container is filled with the composition wherein the composition is hermetically sealed within the internal compartment of the second container from the external surface of the second container.

12. A method for treating a solution, the method comprising the steps of:
producing a composition by mixing a first volume of a catalyst-altered water, a first volume of a colloidal solution and a first volume of water;
sealing a volume of the composition within an internal compartment of a first container wherein the first container has an external surface wherein the volume of the composition is hermetically sealed within the internal compartment of the first container from the external surface of the first container; and
exposing the solution to the first container within a close proximity of the external surface of the first container.

13. The method of claim 12 further comprising the step of:
filtering the first volume of the water with a carbon-filtration process before producing the composition.

14. The method of claim 12 further comprising the step of:
treating the first volume of water by exposing the first volume of water within a close proximity of an external surface of a second container wherein the second container is filled with a preliminary composition wherein the preliminary composition has a second volume of the catalyst-altered water, a second volume of the colloidal solution and a second volume of water.

15. The method of claim 12 further comprising the step of:
housing the first container in a fixture before exposing the solution to the first container.

16. The method of claim 12 wherein the first container is made from plastic.

17. The method of claim 12 wherein the external surface of the first container forms a sphere about a central axis of the first container.

18. The method of claim 12 wherein the external surface of the first container forms a tube about a central axis of the first container.

19. The method of claim 12 wherein the catalyst altered-water is Dr. Willard's™ Water Clear Concentrate.

20. The method of claim 12 wherein the colloidal solution is a silver colloidal solution that is twenty percent silver by volume.
